(19) United States
(12) Patent Application Publication
(10) Pub. No.: US 2026/0183853 A1
(43) Pub. Date: Jul. 2, 2026

(54) METHOD OF DISMANTLING ELECTRICITY STORAGE DEVICE AND APPARATUS OF CUTTING ELECTRICITY STORAGE DEVICE

(71) Applicant: Prime Planet Energy & Solutions, Inc., Tokyo (JP)

(72) Inventor: Yozo UCHIDA, Toyota-shi (JP)

(21) Appl. No.: 19/430,256

(22) Filed: Dec. 23, 2025

(30) Foreign Application Priority Data
Dec. 27, 2024 (JP) 2024-232638

(51) Int. Cl. B23D 59/00; B23D 55/02; B23D 55/06; H01M 10/54

(52) U.S. Cl. CPC B23D 59/0062; B23D 55/023; B23D 55/065; H01M 10/54; B23D 59/001

(57) ABSTRACT

A method of dismantling a battery includes a cutting step, a heating step, and a removing step. In one embodiment, the cutting step cuts a case of the battery with a band saw blade made of a material having a higher melting point than a material making up the case. The heating step heats the band saw blade to a temperature that is higher than the melting point of the material making up the case and is lower than the melting point of the material making up the band saw blade. The removing step removes cutting chips adhering to the band saw blade by applying an external force to the band saw blade that is heated in the heating step.

### CROSS REFERENCE TO RELATED APPLICATIONS

The present application claims priority from Japanese Patent Application No. 2024-232638 filed on Dec. 27, 2024, which is incorporated by reference herein in its entirety.

### BACKGROUND

The present disclosure relates to a method of dismantling electricity storage devices and an apparatus of cutting electricity storage devices.

In the present description, the term “electricity storage device” refers to a device that is capable of charging and discharging. Electricity storage devices include batteries, such as primary batteries and secondary batteries (including nickel-metal hydride batteries, non-aqueous electrolyte secondary batteries such as lithium-ion secondary batteries, and the like) and capacitors (physical energy storage devices), such as electric double-layer capacitors.

JP 2021-073375 A discloses a method for recycling lithium-ion secondary batteries. The method disclosed in the publication includes the following steps of:
(1) discharging a lithium-ion battery;
(2) shredding the lithium-ion battery into small pieces to provide a mixture of a structural portion, a first conductive metal portion coated with a cathode layer, and a second conductive metal portion coated with an anode layer;
(3) immersing the small pieces of the shredded lithium-ion battery in a polar solvent to form a heterogeneous mixture;
(4) processing the heterogeneous mixture with a mixer by mechanical agitation for about 5 minutes to about 5 hours to dissolve a binder material in the cathode layer and the anode layer;
(5) sieving the processed heterogeneous mixture to separate the structural portion, the first conductive metal portion, and the second conductive metal portion from a finer electrode material containing cathode and anode materials to provide a suspension comprising the polar solvent and the finer electrode material; and
(6) isolating the finer electrode material in the suspension from the polar solvent.

### SUMMARY

The present inventor wishes to improve the recycling rate of the materials used in electricity storage devices. From such a viewpoint, the present inventor is investigating sorting electricity storage devices part by part to put forward the recycling. In that process, the present inventor intends to employ a band saw blade to cut electricity storage devices. However, it has been found that when electricity storage devices are cut with a band saw blade, the sharpness of the band saw blade deteriorates gradually, possibly causing cutting failures.

According to the present disclosure, a method of dismantling an electricity storage device includes the steps of cutting, heating, and removing. The step of cutting cuts a case of the electricity storage device with a band saw blade made of a material having a higher melting point than a material making up the case. The step of heating heats the band saw blade to a temperature that is higher than a melting point of the material making up the case and is lower than a melting point of the material making up the band saw blade. The step of removing step removes cutting chips adhering to the band saw blade by applying an external force to the band saw blade that is heated in the step of heating. Such a configuration is able to resolve cutting failures resulting from the band saw blade.

According to the present disclosure, an apparatus of cutting an electricity storage device includes a table, a fixture, a band saw blade, a drive mechanism, a heating device, and a cutting chip removal mechanism. On the table, an electricity storage device including a case is placed. The fixture fixes the electricity storage device placed on the table. The band saw blade is made of a material having a higher melting point than a material making up the case. The drive mechanism drives the band saw blade. The heating device heats the band saw blade. The a cutting chip removal mechanism removes cutting chips adhering to the band saw blade by applying an external force to the band saw blade. Such an apparatus of cutting an electricity storage device is able to suitably perform the above-described method of dismantling an electricity storage device.

### BRIEF DESCRIPTION OF THE DRAWINGS

FIG. 1 is a flowchart illustrating a method of dismantling a battery, according to one embodiment of the present disclosure.

FIG. 2 is a perspective view schematically illustrating a battery to be cut, according to one embodiment of the present disclosure.

FIG. 3 is a schematic vertical cross-sectional view taken along line III-III in FIG. 2.

FIG. 4 is a first schematic view illustrating a battery cutting apparatus according to one embodiment of the present disclosure.

FIG. 5 is a second schematic view illustrating the battery cutting apparatus according to one embodiment of the present disclosure.

FIG. 6 is a schematic view illustrating the state of a battery before being cut, according to one embodiment of the present disclosure.

FIG. 7 is a schematic view illustrating the state of a battery after having been cut, according to one embodiment of the present disclosure.

FIG. 8A is a first schematic view for illustrating a removing step for a battery, according to one embodiment of the present disclosure.

FIG. 8B is a second schematic view for illustrating the removing step for a battery, according to one embodiment of the present disclosure.

FIG. 8C is a third schematic view for illustrating the removing step for a battery, according to one embodiment of the present disclosure.

### DETAILED DESCRIPTION

Hereinbelow, some embodiments of the technology according to the present disclosure will be described with reference to the drawings. Throughout the drawings, like features, parts, and components that exhibit the same or similar workings are referred to by like reference symbols as appropriate. In addition, dimensional relationships (such as length, width, and thickness) shown in the drawings do not necessarily reflect actual dimensional relationships. It should be noted that matters that are other than those specifically described in this description but are required to carry out the technology disclosed herein (such as, for example, the general configurations of electricity storage devices that are not characterized by the present disclosure and the manufacturing processes thereof) may be understood as design considerations for a skilled person in the art based on the prior art in the relevant field. The technology disclosed herein may be implemented based on the contents disclosed in this description and the common general technical knowledge in the related field. Furthermore, the following description is not intended to limit the present disclosure to the embodiments described below. Hereinbelow, a lithium-ion secondary battery (hereinafter referred to simply as a “battery”), which is one embodiment of the electricity storage device disclosed herein, is used as an example in the description. It should be noted that the following description is not intended to limit the electricity storage device to the lithium ion secondary battery.

The recitation of numerical ranges in the present description, such as “A to B”, is meant to include any values between the upper limits and the lower limits, inclusive, that is, “greater than or equal to A to less than or equal to B”. The phrase “A to B” is meant to include “greater than A” and “less than B”.

In the following description, a “battery cutting apparatus” may be referred to simply as a “cutting apparatus”. In addition, a “method of dismantling a battery” may be referred to simply as a “dismantling method”. Also, the term “rectangular parallelepiped” mentioned below may be the concept that encompasses substantially rectangular parallelepipeds with rounded corners, as well as rectangular parallelepipeds. In addition, the term “rectangular” mentioned below may be the concept that encompasses substantially rectangular shapes with rounded corners, as well as rectangular shapes.

In the drawings, reference characters X, Y, and Z indicate a first axis, a second axis, and a third axis, respectively. These axes or directions are, however, defined merely for purposes of illustration. These axes or directions do not limit the manners in which a cutting apparatus 100 is to be arranged in any way.

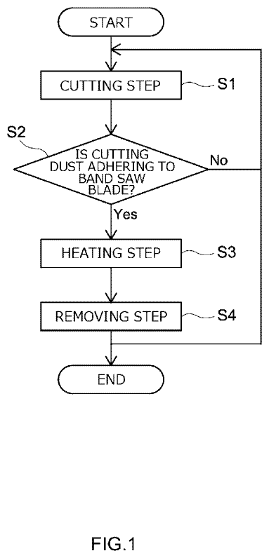

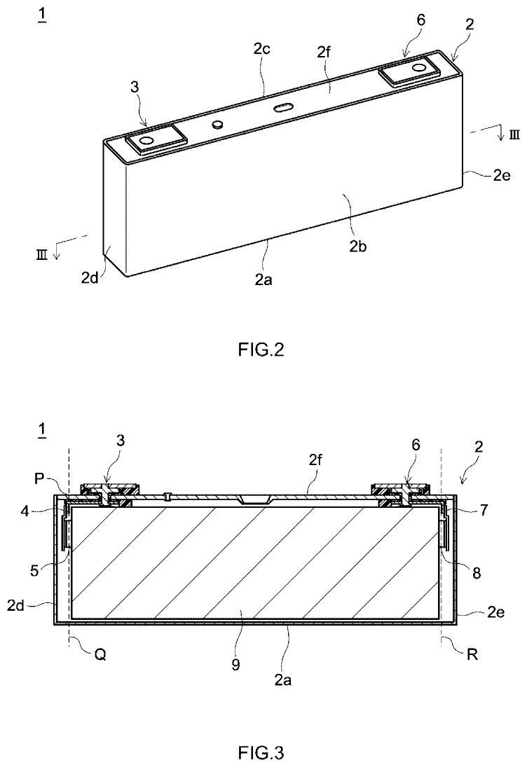

Herein, FIG. 1 is a flowchart illustrating a method of dismantling a battery 1, according to one embodiment of the present disclosure. As illustrated in FIG. 1, the method of dismantling a battery 1 according to the present embodiment includes a cutting step S1, a heating step S3, and a removing step S4. FIG. 2 is a perspective view schematically illustrating the battery 1 to be cut, according to one embodiment of the present disclosure. FIG. 3 is a schematic vertical cross-sectional view taken along line III-III in FIG. 2.

As illustrated in FIGS. 2 and 3, the battery 1 to be cut in the present embodiment includes a case 2, a positive electrode terminal 3, a negative electrode terminal 6, an electrode body 9, and an electrolyte (not shown).

### Case 2

The case 2 is an outer casing member of the battery 1. The case 2 houses the electrode body 9 and the electrolyte. The positive electrode terminal 3 and the negative electrode terminal 6 are attached to the case 2. In the present embodiment, the case 2 has a flat rectangular parallelepiped shape. The case 2 includes a bottom surface 2a, a pair of first side walls 2b and 2c, a pair of second side walls 2d and 2e, and a top surface 2f. The bottom surface 2a is rectangular in shape and is opposed to the top surface 2f. The pair of first side walls 2b and 2c are rectangular-shaped wider surfaces that are opposed to each other. The pair of second side walls 2d and 2e are rectangular-shaped narrower surfaces that are opposed to each other. The area of each of the first side walls 2b and 2c is greater than the area of each of the second side walls 2d and 2e. Herein, it is preferable that the case 2 is made of a metal material. Examples of such a metal material include aluminum, aluminum alloys, stainless steels, and the like. Among them, aluminum and aluminum alloys are particularly preferable as the metal material.

### Positive Electrode Terminal 3 and Negative Electrode Terminal 6

In the embodiment shown in FIGS. 2 and 3, the positive electrode terminal 3 and the negative electrode terminal 6 are disposed on the top surface 2f of the case 2. The positive electrode terminal 3 is connected to the electrode body 9 by a positive electrode current collector 4. Herein, the positive electrode terminal 3 may preferably be made of metal, and more preferably be made of aluminum or an aluminum alloy, for example. The positive electrode current collector 4 may be made of, for example, an electrically conductive metal, such as aluminum, aluminum alloys, nickel, and stainless steels. The negative electrode terminal 6 is connected to the electrode body 9 by a negative electrode current collector 7. Herein, the negative electrode terminal 6 may preferably be made of metal, and more preferably be made of copper or a copper alloy, for example. The negative electrode current collector 7 may be made of, for example, an electrically conductive metal, such as copper, copper alloys, nickel, and stainless steels.

### Electrode Body 9

The electrode body 9 includes, for example, a positive electrode (positive electrode sheet) serving as a positive electrode element, a negative electrode (negative electrode sheet) serving as a negative electrode element, and a separator interposed between the positive electrode sheet and the negative electrode sheet. The electrode body 9 has a flat rectangular parallelepiped shape herein. The type of the electrode body 9 is not limited to any particular type, and may be, for example, a stacked electrode body or a wound electrode body. In the embodiment shown in FIG. 3, the electrode body 9 includes a positive electrode tab group 5 in which a plurality of positive electrode tabs are laminated at one end (the left end in FIG. 3) of the longer side direction. The positive electrode tab group 5 is electrically connected to the positive electrode terminal 3 via the positive electrode current collector 4. The positive electrode tabs herein are part of the positive electrode current collector and are made of a metal foil (aluminum foil). Also, in the embodiment shown in FIG. 3, the electrode body 9 includes a negative electrode tab group 8 in which a plurality of negative electrode tabs are laminated at one end (the right end in FIG. 3) of the longer side direction. The negative electrode tab group 8 is electrically connected to the negative electrode terminal 6 via the negative electrode current collector 7. The negative electrode tabs herein are part of the negative electrode current collector and are made of a metal foil (copper foil). Note that, for each of the components, including the positive electrode terminal 3, the positive electrode current collector 4, the negative electrode terminal 6, the negative electrode current collector 7, and the electrode body 9, and for the electrolyte, it is possible to use the components that are usable in this type of battery 1.

### Cutting Apparatus 100

Next, a cutting apparatus 100 for cutting such a battery 1 as an electricity storage device will be described below.

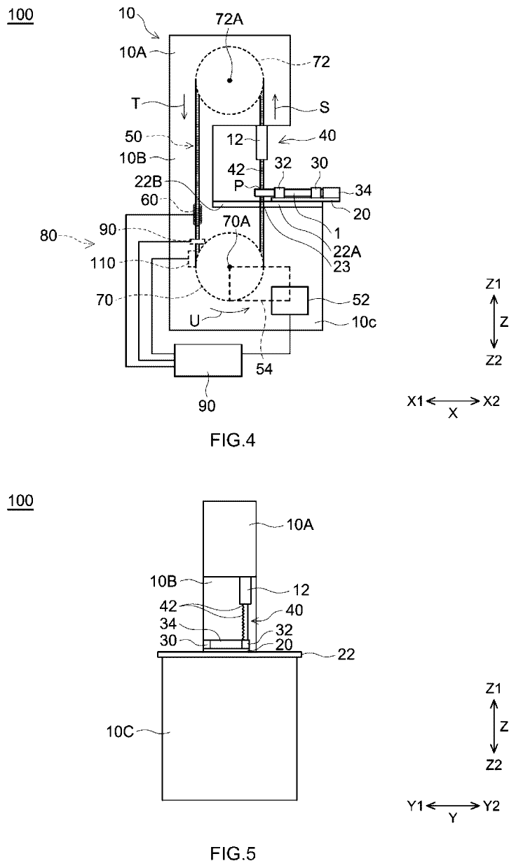

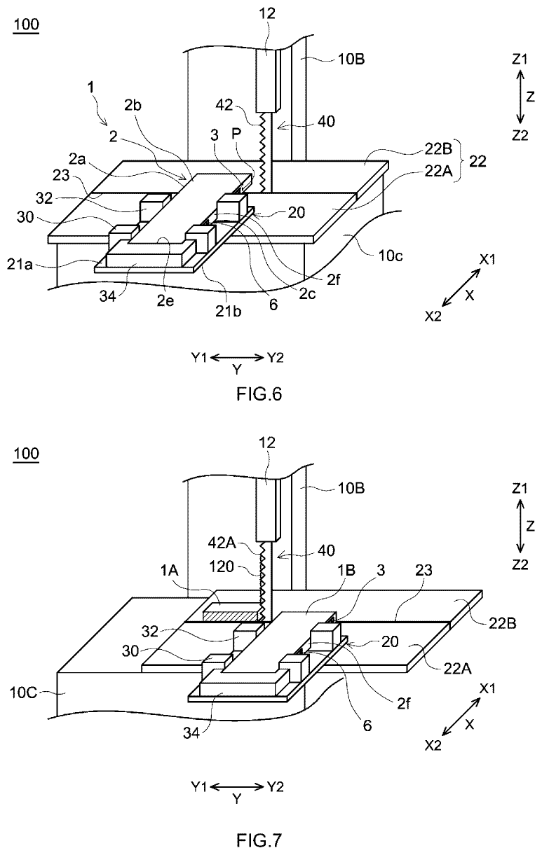

FIG. 4 is a side view of the cutting apparatus 100. FIG. 5 is a second schematic view illustrating the cutting apparatus 100 for the battery 1, according to one embodiment of the present disclosure. FIG. 5 is a front view of the cutting apparatus 100. FIG. 6 is a schematic view illustrating the state of the battery 1 before being cut, according to one embodiment of the present disclosure. FIG. 7 is a schematic view illustrating the state of the battery 1 after having been cut, according to one embodiment of the present disclosure.

As illustrated in FIGS. 4 and 5, the cutting apparatus 100 includes a table 20, fixtures 30, 32, and 34, a band saw blade 40, a drive mechanism 50, and a heating device 60. The cutting apparatus 100 may be, for example, a contour saw machine or a band saw machine. Hereinbelow, each of the components will be described. In the present embodiment, each component of the cutting apparatus 100 is disposed in a housing 10. The housing 10 includes an upper housing portion 10A, a middle housing portion 10B, and a lower housing portion 10C.

### Housing Portions 10A, 10B, and 10C

In the present embodiment, as illustrated in FIGS. 4 and 5, the cutting apparatus 100 includes the housing 10 for housing the elements necessary for cutting the battery 1. In the embodiment shown in FIG. 4, the housing 10 includes three housing portions, the upper housing portion 10A, the middle housing portion 10B, and the lower housing portion 10C. The upper housing portion 10A and the lower housing portion 10C are connected by the middle housing portion 10B. The outer shape of each of the housing portions herein is a rectangular parallelepiped shape. In the present embodiment, the upper housing portion 10A houses a later-described second saw wheel 72. The lower housing portion 10C houses a later-described first saw wheel 70. The middle housing portion 10B houses a portion of band saw blade 40 wrapped on the first saw wheel 70 and the second saw wheel 72. The materials making up the housing portions are not limited to any particular material herein, but the housing portions may preferably be made of a metal material. Examples of such a metal material include aluminum, aluminum alloys, stainless steels, and the like. Note that the materials making up the housing portions may be the same as or different from each other. In addition, the sizes of the housing portions may be determined as appropriate depending on, for example, the sizes of the first saw wheel 70, the second saw wheel 72, and the band saw blade 40, the environment in which the cutting apparatus 100 is arranged, and the like.

### Table 20

The table 20 is a member on which the battery 1 including the case 2 is to be placed. As illustrated in FIG. 6, in the present embodiment, the table 20 is a rectangular plate-shaped member (i.e., plate). The table 20 includes a pair of rectangular wider surfaces 21a and 21b. Herein, the table 20 is placed on a pedestal 22 disposed on the lower housing portion 10C. As illustrated in FIGS. 6 and 7, in the present embodiment, the table 20 is configured to be movable along the second axis Y by the pedestal 22. In the present embodiment, the pedestal 22 moves along the second axis Y, thereby causing the table 20 fixed on the pedestal 22 to move in directions along the second axis Y. The pedestal 22 herein includes a first pedestal portion 22A and a second pedestal portion 22B. In this embodiment, each of the first pedestal portion 22A and the second pedestal portion 22B is a rectangular plate-shaped member (i.e., plate). Herein, the first pedestal portion 22A is a member for moving the battery 1 fixed on the table 20. The second pedestal portion 22B is a member for catching a battery cut piece 1A that is obtained after cutting the battery 1. A clearance gap 23 is present between the first pedestal portion 22A and the second pedestal portion 22B. Even when the later-described band saw blade 40 exists, the clearance gap 23 is provided so that the pedestal 22 can move along the second axis Y. The pedestal 22 may be moved either manually or by an electric motor or the like. The materials making up the table 20 and the pedestal 22 are not limited to any particular material herein, but it is preferable that they be made of a metal material. Examples of such a metal material include aluminum, aluminum alloys, stainless steels, and the like. Note that the size of the table 20 may be a size such that the battery 1 to be cut may be placed thereon and may be determined as appropriate depending on, for example, the size of the battery 1. Also, the size of the pedestal 22 may be a size such that the table 20 may be placed thereon and may be determined as appropriate depending on, for example, the size of the table 20.

### Fixtures 30, 32, and 34

Fixtures 30, 32, and 34 are members that fix the battery 1 placed on the table 20. As illustrated in FIG. 6, the fixtures 30, 32, and 34 are in an angular C-shape in the present embodiment. The fixtures 30 and 32 are placed on the table 20 so as to fix the bottom surface 2a and the top surface 2f of the case 2. The fixture 34 is placed on the table 20 so as to fix the second side wall 2e of the case 2. Each of the fixtures herein is configured to be able to adjust the distance between its opposite ends according to the size of the battery 1. The materials making up the fixtures herein are not limited to any particular material, but the fixtures may be preferably made of a metal material. Examples of the metal material making up the fixtures include aluminum, aluminum alloys, stainless steels, and the like. Note that the materials making up the fixtures may be the same as or different from each other. In addition, the sizes of the fixtures may be the same as or different from each other. The size of each of the fixtures may be a size such as to be able to fix the battery 1 to be cut and may be determined as appropriate depending on, for example, the size of the battery 1.

### Band Saw Blade 40

The band saw blade 40 is a member that cuts the battery 1. The band saw blade 40 is a band-shaped saw blade. As illustrated in FIG. 4, in the present embodiment, the band saw blade 40 extends in a direction along a cut position P of the battery 1 (along the third axis Z). Although not particularly limited thereto, the band saw blade 40 used herein may be one in which the ratio of the length of the band saw blade 40 along the width axis (the second axis Y) of the band saw blade 40 and the length of the band saw blade 40 along its extending axis (the third axis Z) is, for example, 1:100 to 1:1000 (preferably 1:200 to 1:500). As illustrated in FIG. 4, in the present embodiment, the band saw blade 40 is an annular band saw blade.

As illustrated in FIG. 5, in the present embodiment, the band saw blade 40 includes a plurality of blade teeth tips 42. Each of the plurality of blade teeth tips 42 has a pointed triangular shape. The plurality of blade teeth tips 42 are arranged at a predetermined pitch. The plurality of blade teeth tips 42 may be disposed at least on a side of the band saw blade 40 that faces the cut position P of the battery 1. For example, as illustrated in FIG. 5, in the present embodiment, the plurality of blade teeth tips 42 are arranged along one side of the width axis of the band saw blade 40 (i.e., one side facing one end Y1 along the second axis Y). In the embodiment shown in FIG. 4, a portion of the band saw blade 40 is covered by a cover part 12.

The material making up the band saw blade 40 herein is not limited to any particular material, but it is preferable that it be made of a metal material. It is preferable that such a metal material be a material having a higher melting point than the material making up the case 2. Examples of the metal material include iron, iron alloys, and steel materials such as carbon steels. It is preferable that the metal material making up the band saw blade 40 be, for example, harder (in other words, greater in Vickers hardness value HV) than the metal material making up the case 2. This allows the band saw blade 40 to be unlikely to be damaged when cutting the battery 1. The difference between the Vickers hardness of the metal material making up the band saw blade 40 and the Vickers hardness of the metal material making up the case 2 is, for example, greater than or equal to 5 HV, preferably greater than or equal to 10 HV or greater than or equal to 20 HV, more preferably greater than or equal to 30 HV or greater than or equal to 40 HV. The upper limit of the difference in Vickers hardness as just mentioned above is, for example, less than or equal to 100 HV, or may be less than or equal to 50 HV. For the Vickers hardness as just mentioned above, it is possible to adopt the values measured according to ISO 6507. The hardness of the band saw blade 40 may be adjusted as appropriate according to the hardness of various members of the battery 1 to be cut. In addition, the length and thickness of the band saw blade 40 and the number and pitch of the plurality of blade teeth tips 42 provided on the band saw blade 40 may be determined as appropriate according to the type, size, and the like of the battery 1 to be cut. For such a band saw blade 40, it is possible to use a band saw blade for what is called a rotary band saw.

### Drive Mechanism 50

The drive mechanism 50 is a mechanism that drives the band saw blade 40. The drive mechanism 50 herein is configured to drive the band saw blade 40 in a direction along the cut position P of the band saw blade 40 (along the third axis Z). In the embodiment shown in FIG. 4, the drive mechanism 50 includes a first saw wheel 70, a second saw wheel 72, and a drive device 52. Herein, each of the first saw wheel 70 and the second saw wheel 72 is a saw wheel on which the band saw blade 40 is wrapped. In the present embodiment, the first saw wheel 70 is disposed below the table 20. The second saw wheel 72 is disposed above the table 20. The first saw wheel 70 and the second saw wheel 72 are disposed so as to be aligned vertically with each other above and below the table 20. The first rotary shaft 70A of the first saw wheel 70 and the second rotary shaft 72A of the second saw wheel 72 are directed respectively in predetermined directions that are parallel to the table 20. The drive device 52 is a device that drives the band saw blade 40. In the present embodiment, the drive device 52 is configured to rotatively drive the first saw wheel 70 as the drive wheel. The drive device 52 is composed of, for example, a servomotor, and it causes the first rotary shaft 70A to rotate via a power transmitting means 54. Also, the first saw wheel 70 may be configured to rotate in accordance with the rotation of the first rotary shaft 70A. The power transmitting means 54 may be, for example, a gear or belt mechanism. The outer shape of the power transmitting means 54 herein is rectangular. The band saw blade 40 is wrapped around the first saw wheel 70 and the second saw wheel 72. The second saw wheel 72 rotates in response to the rotation of the first saw wheel 70, with the band saw blade 40 being wrapped therearound.

Herein, by being driven by the drive device 52, the band saw blade 40 runs along a predetermined circular path that is defined by the first saw wheel 70 and the second saw wheel 72. The drive device 52 causes the first saw wheel 70 to rotate to thereby drive the band saw blade 40 along a predetermined circular path. In this embodiment, the path along which the band saw blade 40 runs is configured to trace an elliptic path (oval path), as illustrated in FIG. 4, that vertically passes the predetermined cut position P set on the table 20, traces an arc along the first saw wheel 70 and the second saw wheel 72, and returns to the cut position P. Also, the drive device 52 may cause the band saw blade 40 to turn in a forward direction (anti-clockwise in FIG. 4), which is along the arrows S, T, and U, or to turn in the reverse direction. The band saw blade 40 may be configured, for example, to cut the workpiece material placed on the table 20 when turning in the forward direction and not to cut the workpiece material when turning in the reverse direction. Note that the band saw blade 40 herein runs along a circular path.

### Heating Device 60

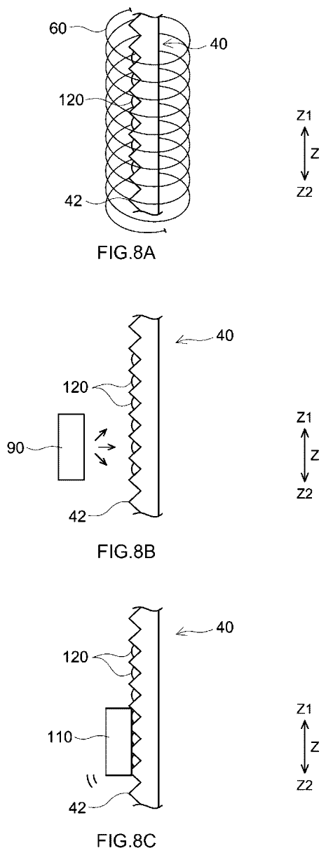

The heating device 60 is a device that heats the band saw blade 40. The heating device 60 may employ, for example, one that makes use of induction heating (IH). As illustrated in FIG. 4, in the present embodiment, the heating device 60 is an induction heating coil. The band saw blade 40 herein is heated by electromagnetic induction of the induction heating coil. Such an induction heating coil is connected to, for example, a power source (not shown). As illustrated in FIG. 8A described later, in the present embodiment, the band saw blade 40 is disposed so as to pass through the center of the induction heating coil. When electric current is passed through the induction heating coil, a magnetic field is generated therearound. This causes electric current to pass through the band saw blade 40, which is disposed at the center of the induction heating coil. For example, because the band saw blade 40 made of a metal material has electrical resistance, the band saw blade 40 generates heat. In this manner, the band saw blade 40 can be heated by the induction heating coil. When an induction heating coil is used as the heating device 60, it is preferable that the band saw blade 40 be made of, for example, a steel material or the like. It is also preferable that the case 2 of the battery 1 to be cut be made of, for example, aluminum or an aluminum alloy.

The value of the current to be passed through the induction heating coil may be determined as appropriate according to, for example, the materials making up the band saw blade 40 and the cutting chips 120. In one embodiment, the value of the current to be passed through the induction heating coil may be set to, for example, 10 A to 100 A, preferably 20 A to 50 A. For example, in the embodiment shown in FIG. 4, the heating device 60 is disposed rearward relative to a cutting chip removal mechanism 80 in the drive direction of the band saw blade 40 (the direction along the arrows S, T, and U herein). In the present embodiment, the heating device 60 is housed in the lower housing portion 10C. Note that the size of the heating device 60 may be determined to be an appropriate size depending on, for example, the size of the cutting apparatus 100 and the like. In addition, the time for which the band saw blade 40 is to be heated by the induction heating coil may be determined appropriately depending on the form or the like of the cutting chips 120. The induction heating coil may be, for example, any conventionally induction heating coil.

### Cutting Chip Removal Mechanism 80

The cutting chip removal mechanism 80 is a mechanism that applies an external force to the band saw blade 40 to remove the cutting chips adhering to the band saw blade 40. As illustrated in FIG. 4, in the present embodiment, the cutting chip removal mechanism 80 includes a blowing device 90 and a brush 110. The cutting chip removal mechanism 80 removes the cutting chips adhering to the band saw blade 40 by blowing air onto the band saw blade 40 using the blowing device 90. Also, the cutting chip removal mechanism 80 removes the cutting chips adhering to the band saw blade 40 by contacting the brush 110 with the band saw blade 40. In the embodiment shown in FIG. 4, the cutting chip removal mechanism 80 is disposed forward relative to the heating device 60 in the drive direction of the band saw blade 40 (the direction along the arrows S, T, and U herein). Hereinafter, the blowing device 90 and the brush 110 are described.

### Blowing Device 90

The blowing device 90 is a device that blows air onto the band saw blade 40. The blowing device 90 blows air to the locations between the plurality of blade teeth tips 42 provided on the band saw blade 40. The blowing device 90 herein has a rectangular parallelepiped shape. In the embodiment shown in FIG. 4, the blowing device 90 is disposed forward relative to the heating device 60 in the drive direction of the band saw blade 40 (the direction along the arrows S, T, and U herein). In the present embodiment, the blowing device 90 is housed in the lower housing portion 10C. The force, amount, and the like of the air that is blown to the band saw blade 40 by the blowing device 90 may be set as appropriate depending on the size of the battery 1 and the like. The blowing device 90 may be, for example, any conventionally known blowing device.

### Brush 110

In the embodiment shown in FIG. 4, the cutting apparatus 100 further includes a brush 110. The brush 110 is a brush that is contacted with the band saw blade 40. The brush 110 herein has a rectangular parallelepiped shape. In the present embodiment, the brush 110 is configured to be vibratable. The brush 110 may be connected to an electric motor, for example. The vibration frequency of the brush 110 may be determined as appropriate depending on, for example, the size of the band saw blade 40. In one embodiment, the vibration frequency of the brush 110 may be set to 1 Hz to 100 Hz, preferably 10 Hz to 50 Hz. In the embodiment shown in FIG. 4, the brush 110 is disposed forward relative to the heating device 60 and the blowing device 90 in the drive direction of the band saw blade 40 (the direction along the arrows S, T, and U herein). In the present embodiment, the brush 110 is housed in the lower housing portion 10C. The material making up the brush 110 is not limited to any particular material but may preferably be a synthetic fiber. Examples of such a synthetic fiber include nylon, polypropylene, vinyl chloride, polyester, and the like. The size of the brush 110 may be determined as appropriate depending on, for example, the size of the region of the band saw blade 40 with which the brush 110 is contacted. The time for which the brush 110 is to be contacted with the band saw blade 40 may be determined depending on the form or the like of the cutting chips 120. The brush 110 may be, for example, a conventionally known one.

### Controller 92

The heating device 60, the blowing device 90, and the brush 110 herein are controlled by a controller 92. The controller 92 controls, for example, the magnitude of the output of the heating device 60 and the timing at which the heating device 60 heats the band saw blade 40. The controller 92 also controls, for example, the timing for driving the blowing device 90 and the brush 110. It should be noted that the configuration of the controller itself does not characterize the technology disclosed herein, so a more detailed description thereof is not provided.

The controller 92 may also control, for example, the drive mechanism 50 (the drive device 52). Specifically, the controller 92 may control the speed at which the drive mechanism 50 drives the band saw blade 40, the direction in which the band saw blade 40 is driven, or the like. The speed at which the drive mechanism 50 drives the band saw blade 40 or the like may be determined as appropriate according to the type, size, and the like of the battery 1 to be cut. In the present embodiment, the controller 92 is disposed external to the housing 10.

Hereinafter, a method of dismantling a battery 1 that is implemented by the cutting apparatus 100 will be described. Herein, the description is provided together with the explanation about the cutting apparatus 100 when appropriate. It should be noted that the following description is not intended to limit the method of dismantling a battery 1 disclosed herein to the embodiments described below. The steps described below may be performed in any order as appropriate as long as the advantageous effects of the technology disclosed herein are obtained. It is also possible to omit any of the steps described below as appropriate. Moreover, additional steps may further be added to the steps described below.

### Dismantling Method

As illustrated in FIG. 1, the method of dismantling a battery 1 according to the present embodiment includes a cutting step S1, a heating step S3, and a removing step S4. FIGS. 8A, 8B, and 8C are a first schematic view, a second schematic view, and a third schematic view, respectively, for illustrating the removing step S5 for a battery 1 according to one embodiment. FIG. 8 is a schematic view for illustrating the brushing step S6 according to one embodiment. Hereinbelow, each of the steps will be described.

First, a battery 1 to be cut is prepared that includes a case 2. The just-mentioned battery 1 to be prepared may be, for example, a battery 1 as described above.

### Cutting Step S1

This step involves cutting the case 2 with a band saw blade 40 made of a material having a higher melting point than the material making up the case 2. As described previously, in the present embodiment, the band saw blade 40 is an annular band saw blade, as illustrated in FIG. 4. Specifically, first, the prepared battery 1 is placed on the table 20 of the cutting apparatus 100 in a predetermined orientation. As illustrated in FIG. 6, in the present embodiment, the battery 1 is placed in such a manner that the first side wall 2b, which is one of the pair of first side walls 2b and 2c, faces the wider surface 21a, which is one of the pair of wider surfaces 21a and 21b of the table 20. The top surface 2f of the case 2, which is provided with the positive electrode terminal 3 and the negative electrode terminal 6, is disposed herein so as to face the plurality of blade teeth tips 42 of the band saw blade 40. Next, the battery 1 placed in the above-described manner is fixed by the fixtures 30, 32, and 34. Then, when cutting the battery 1, the band saw blade 40 runs in a predetermined direction along a predetermined circular path (the path along the arrows S, T, and U herein) to cut the battery 1 at a predetermined cut position P.

The cut position P of the battery 1 is not limited to any particular position as long as the battery 1 can be dismantled. However, it is preferable that, for example, the case 2, the positive electrode terminal 3, the negative electrode terminal 6, and the electrode body 9 be easily separated after the battery 1 is dismantled. From such a viewpoint, in the present embodiment, the cut position P of the battery 1 is set to at a position closer to one end X1 along the first axis X such that the positive electrode terminal 3 and the main part of the electrode body 9 are not cut. As shown in FIG. 3, in the present embodiment, the band saw blade 40 passes through the top surface 2f of the case 2, the positive electrode current collector 4 and the positive electrode tab group 5 inside the case 2, and the bottom surface 2a of the case 2 in that order, to thereby cut the battery 1. That is, in the present embodiment, the band saw blade 40 cuts the battery 1 along dashed line Q. This allows the positive electrode terminal 3 side of the case 2 of the battery 1 to be cut.

As illustrated in FIGS. 6 and 7, when cutting the battery 1, the table 20 on which the battery 1 is placed is moved along the second axis Y by the pedestal 22 while driving the band saw blade 40. In the present embodiment, the table 20 is moved from one end Y1 toward the other end Y2 along the second axis Y. After cutting the battery 1 in such a way, cut pieces 1A and 1B of the battery 1 are obtained.

In dismantling the battery 1, it is necessary to also cut the negative electrode terminal 6 side of the case 2 in order to remove the electrode body 9 from the case 2. For this reason, in the present embodiment, the battery 1 is turned over, and the negative electrode terminal 6 side of the case 2 is cut with the band saw blade 40. In this case, the band saw blade 40 passes through the top surface 2f of the case 2, the negative electrode current collector 7, the negative electrode tab group 8, and the bottom surface 2a of the case 2 in that order. That is, the band saw blade 40 cuts the battery 1 along dashed line R. In this manner, it is possible to cut the negative electrode terminal 6 side of the case 2 of the battery 1. After such cutting, the electrode body 9 is pushed out through the cut opening of the case 2. Then, the top surface 2f of the case 2, the positive electrode terminal 3, and the negative electrode terminal 6 are separated. In the above-described manner, the battery 1 can be dismantled.

When continuously cutting the case 2 of an electricity storage device using the band saw blade 40, it means that the band saw blade 40 continuously cuts the case 2, which is made of aluminum. The present inventor found that, as illustrated in FIG. 7, the adhering (i.e., stuck) cutting chips 120 remain between the blade teeth tips 42 of the band saw blade 40, gradually deteriorating the sharpness of the band saw blade 40. The present inventor believes that such an event occurs because the heat generated during cutting causes fine cutting chips produced during cutting aluminum to adhere and gradually accumulate onto the blade teeth tips 42 of the band saw blade 40. In view of this, the present inventor devised addition of the heating step S3 and the removing step S4 described below.

As illustrated in FIG. 1, in the present embodiment, after the cutting step S1, it is determined whether or not the cutting chips 120 are adhered to the band saw blade 40 (step S2). Then, if the cutting chips 120 are not adhered to the band saw blade 40 (if “NO”), the process returns to the cutting step S1 and continues to cut the battery 1. On the other hand, if the cutting chips 120 are adhered to the band saw blade 40 (if “YES”), the process proceeds to the heating step S3.

### Heating Step S3

This step involves heating the band saw blade 40 to a temperature that is higher than the melting point of the material making up the case 2 and is lower than the melting point of the material making up the band saw blade 40. In other words, this step involves heating the band saw blade 40 to a temperature that is higher than the melting point of the cutting chips 120 adhering to the band saw blade 40 and is lower than the melting point of the material making up the band saw blade 40. As described previously, the present embodiment uses an induction heating coil as the heating device 60. As illustrated in FIG. 8A, in the present embodiment, the band saw blade 40 is heated by electromagnetic induction using the induction heating coil. For example, when the band saw blade 40 is made of a steel material, it is desirable as the heating target for the induction heating coil. On the other hand, because the cutting chips 120, which may form when cutting the battery 1, contain much of the material of the case 2 of the battery 1, it is preferable that the case 2 of the battery 1 be made of aluminum or an aluminum alloy. When the cutting chips 120 contain such a metal material, it is desirable as the heating target. The heating device 60 may preferably heat the band saw blade 40 at a temperature that is higher than the melting point of the aluminum or aluminum alloy and is lower than the melting point of the steel material (which is, for example, 670° C. to 1500° C.).

As illustrated in FIG. 8A, in the present embodiment, the band saw blade 40 is disposed so as to pass through the center of the induction heating coil. Also, in the present embodiment, driving of the band saw blade 40 is stopped, and the blade teeth tips 42 to which the cutting chips 120 are adhered are heated by the induction heating coil. In this manner, the cutting chips 120 adhering between the blade teeth tips 42 of the band saw blade 40 are melted.

### Removing Step S4

This step involves applying an external force to the band saw blade 40 that has been heated in the above-described heating step S3 to remove the cutting chips 120 adhering to the band saw blade 40. As illustrated in FIG. 8B, as the external force, the air is blown between the blade teeth tips 42 of the heated band saw blade 40 in the present embodiment. Note that the arrows in FIG. 8B represent the air. As illustrated in FIG. 8C, as the external force, the brush 110 is contacted between the blade teeth tips 42 of the heated band saw blade 40 in the present embodiment. In the embodiment shown in FIG. 8C, the brush 110 is contacted with the band saw blade 40 while vibrating the brush 110. Further, the brush 110 is contacted with the band saw blade 40 while running the band saw blade 40 in the opposite direction (the direction toward one end Z1 along the third axis Z herein) to a predetermined direction (the direction along the arrows S, T, and U herein). In this manner, the cutting chips 120 that have been melted in the heating step S3 are removed.

As illustrated in FIG. 1, in the present embodiment, after the cutting chips 120 adhering to the band saw blade 40 are removed by the removing step S4, the process returns to the cutting step S1 again. Note that whether or not the cutting chips 120 are adhered to the band saw blade 40 may be checked by, for example, monitoring with a monitor or the like.

As already described above, the method of dismantling a battery 1 according to the present embodiment includes the cutting step S1, the heating step S3, and the removing step S4. Generally, because cutting of batteries 1 is performed in a dry environment in many cases, cutting chips (for example, cutting chips of aluminum) are likely to adhere to the band saw blade 40. In view of this, with the method of dismantling a battery 1 according to the present embodiment, in the above-described cutting step S1, the case 2 is cut with the band saw blade 40 made of a material having a higher melting point than the material making up the case 2 of the battery 1. Then, in the above-described heating step S3, the band saw blade 40 is heated to a temperature that is higher than the melting point of the material making up the case 2 and is lower than the melting point of the material making up the band saw blade 40. Thus, in the above-described heating step S3, the cutting chips 120 adhering to the band saw blade 40 and originating from the case 2 can be melted by heating the band saw blade 40 at a temperature as described above. Moreover, because the band saw blade 40 is made of a material having a higher melting point than the material making up the case 2, it is possible to prevent damages to the band saw blade 40 suitably even when the cutting chips 120 are melted. Then, in the above-described removing step S4, an external force is applied to the band saw blade 40 that has been heated in the above-described heating step S3 to remove the cutting chips 120 adhering to the band saw blade 40. In this manner, it is possible to suitably remove the cutting chips 120, which are adhered to the band saw blade 40 by cutting the battery 1. This makes it possible to resolve cutting failures resulting from the band saw blade 40. Then, with the band saw blade 40 without the cutting chips 120 adhering thereto, dismantling of a next one of batteries 1 can be continuously carried out. Such a method of dismantling a battery 1 may be implemented by, for example, a cutting apparatus 100 including a table 20, fixtures 30, 32, and 34, a band saw blade 40, a drive mechanism 50, a heating device 60, and a cutting chip removal mechanism 80.

As described previously, in the present embodiment, the material of the case 2 of the battery 1 is aluminum or an aluminum alloy, and the material of the band saw blade 40 is a steel material. Such a combination makes it possible to suitably perform dismantling of a battery 1.

In such an embodiment, in the above-described heating step S3, the band saw blade 40 is heated by electromagnetic induction using the induction heating coil. In the present embodiment, the heating device 60 is an induction heating coil. For example, when an induction heating coil is used as the heating device 60, it is preferable that the band saw blade 40, which is the heating target, be made of, for example, a steel material or the like. On the other hand, because the cutting chips 120, which may form when cutting the battery 1, contain much of the material of the case 2 of the battery 1, it is preferable that the case 2 of the battery 1 be made of aluminum or an aluminum alloy. When the cutting chips 120 contain such a metal material, it is desirable as the heating target. It should be noted that the advantages of using the induction heating coil as the heating device 60 may include the following. For example, when an resistive heating device is used as the heating device 60, it is necessary to pass electric current directly through the band saw blade 40, which makes management difficult. In contrast, when an induction heating coil is used as the heating device 60, the band saw blade 40 can be heated in a non-contact manner, so management is easy. Moreover, the induction heating coil is preferable because it is easier to adjust the temperature with electric current. On the other hand, for example, when a burner is used as the heating device 60, it is likely to cause thermal effects on the members therearound. In contrast, when an induction heating coil is used as the heating device 60, thermal effects on the members therearound are less because the band saw blade 40 is heated directly,

As described previously, the method of dismantling a battery 1 according to the present embodiment includes contacting the brush 110 with the band saw blade 40 in the removing step S4. This makes it possible to remove the cutting chips 120 adhering to the band saw blade 40 more reliably. Such a method of dismantling a battery 1 may be implemented by, for example, a cutting apparatus 100 that further includes a brush 110, in addition to the constituent elements described above. Moreover, as described previously, in the present embodiment, the brush 110 is caused to vibrate in the removing step S4. This makes it possible to remove the cutting chips 120 adhering to the band saw blade 40 even more reliably. Such a method of dismantling a battery 1 may be implemented by, for example, a cutting apparatus 100 that further includes a brush 110 configured to be vibratable, in addition to the constituent elements described above.

As described above, the method of dismantling a battery 1 according to the present embodiment uses an annular band saw blade as the band saw blade 40. In addition, in the cutting step S1, the band saw blade 40 runs in a predetermined direction along a predetermined circular path (the path along the arrows S, T, and U herein) to cut the battery 1 at a predetermined cut position P. Cutting the battery 1 using an annular band saw blade 40 in this manner enables the battery 1 to be dismantled more efficiently and continuously. Such a method of dismantling a battery 1 may be implemented by, for example, a cutting apparatus 100 that further includes a first saw wheel 70, a second saw wheel 72, and a drive device 52, in addition to the constituent elements described above.

In such an embodiment, in the above-described removing step S4, the brush 110 is contacted with the band saw blade 40 while running the band saw blade 40 in the opposite direction to a predetermined direction (the path along the arrows S, T, and U herein). This makes it possible to remove the cutting chips 120 adhering to the band saw blade 40 more reliably.

As described previously, in the present embodiment, the cutting chip removal mechanism 80 is disposed forward relative to the heating device 60 in the drive direction of the band saw blade 40 (the direction along the arrows S, T, and U herein). Such a configuration makes it possible to remove the cutting chips 120 adhering to the band saw blade 40.

As described previously, the method of dismantling a battery 1 according to the present embodiment includes blowing the air onto the band saw blade 40 in the removing step S4. This makes it possible to remove the cutting chips 120 adhering to the band saw blade 40 more reliably. Such a method of dismantling a battery 1 may be implemented by, for example, a cutting apparatus 100 that further includes a blowing device 90, in addition to the constituent elements described above.

Hereinabove, some embodiments of the technology disclosed herein have been described. It should be understood, however, that the foregoing description is merely exemplary and is not intended to limit the scope of the claims. Various modifications and alterations of the above-described examples illustrated in the foregoing description are also within the scope of the disclosure as defined by the appended claims.

For example, although the shape of the case 2 of the battery 1 is a flat rectangular parallelepiped shape in the foregoing embodiments, this is merely exemplary. In other embodiments, the shape of the case 2 of the battery 1 may be various other shapes, including a cylindrical shape and a laminate type. Moreover, although the positive electrode terminal 3 and the negative electrode terminal 6 are disposed on the top surface 2f of the case 2 in the foregoing embodiments, this is merely exemplary. In other embodiments, the positive electrode terminal 3 and the negative electrode terminal 6 may be disposed on one of the pair of the second side walls 2d and 2e. Alternatively, the positive electrode terminal 3 and the negative electrode terminal 6 may be disposed respectively on the second side walls 2d and 2e. For example, in the former case, the cut position may be set at a position in the battery 1 that is closer to the one of the second side walls on which the positive electrode terminal 3 and the negative electrode terminal 6 are disposed.

In this case, for example, the cut position may be provided so that the band saw blade 40 passes through the top surface 2f of the case 2, the positive electrode tab group 5, the negative electrode tab group 8, and the bottom surface 2a of the case 2, in that order. Alternatively, in the latter case, for example, the cut position may be provided so that the band saw blade 40 passes through the top surface 2f of the case 2, the positive electrode tab group 5 (or the negative electrode tab group 8), and the bottom surface 2a of the case 2, in that order.

For example, although the electrode body 9 includes the positive electrode tab group 5 and the negative electrode tab group 8 in the foregoing embodiments, this is merely exemplary. In other embodiments, the electrode body 9 may include a positive electrode active material layer exposed portion and a negative electrode active material layer exposed portion in place of the positive electrode tab group 5 and the negative electrode tab group 8, respectively. In this case, for example, in cutting the battery 1, the cut position may be provided so that the band saw blade 40 passes through the top surface 2f of the case 2, the positive electrode current collector 4 (or the negative electrode current collector 7), the positive electrode active material layer exposed portion (or the negative electrode active material layer exposed portion), and the bottom surface 2a of the case 2, in that order.

For example, although the positive electrode terminal 3 and the negative electrode terminal 6 are disposed so as to face the plurality of blade teeth tips 42 of the band saw blade 40 in the foregoing embodiments, this is merely exemplary. The manner of placement of the battery 1 on the table 20 is not limited to any particular manner as long as the advantageous effects of the technology disclosed herein are obtained. In other embodiments, for example, it is possible that the bottom surface 2a of the battery 1, on which the positive electrode terminal 3 and the negative electrode terminal 6 are not provided, be disposed so as to face the plurality of blade teeth tips 42 of the band saw blade 40. In this case, in cutting the battery 1, the cut position may be provided so that the band saw blade 40 passes through the bottom surface 2a of the case 2, the positive electrode tab group 5 (or the negative electrode tab group 8), the positive electrode current collector 4 (or the negative electrode current collector 7), and the top surface 2f of the case 2, in that order.

For example, although the outer shape of each of the housing portions of the cutting apparatus 100 is a rectangular parallelepiped shape in the foregoing embodiments, this is merely exemplary. In other embodiments, the shape of each housing portion may be various other shapes, such as cylinder, elliptic cylinder, polygon, and the like. Furthermore, although the table 20 and the pedestal 22 are rectangular plate-shaped members in the foregoing embodiments, this is merely exemplary. In other embodiments, the shape of the table 20 and the pedestal 22 may be flat cylinder, elliptic cylinder, or polygon.

For example, although the table 20 on which the battery 1 is placed is moved along the second axis Y by the pedestal 22 when cutting the battery 1 in the foregoing embodiments, this is merely exemplary. In other embodiments, when cutting the battery 1, only the table 20 may be moved along the second axis Y without using the pedestal 22.

For example, although the fixtures 30, 32, and 34 have an angular C-shape in the foregoing embodiments, this is merely exemplary. In other embodiments, the fixtures may have various other shapes. In addition, although the number of the fixtures is three in the foregoing embodiments, this is merely exemplary. In other embodiments, the number of the fixtures may be one or two, or even four or more.

For example, although the band saw blade 40 is an annular band saw blade in the foregoing embodiments, this is merely exemplary. In other embodiments, the band saw blade 40 may be a linearly extending band saw blade (jigsaw). For example, when the band saw blade 40 is linear, the battery 1 may be cut by reciprocating the band saw blade 40 linearly. In addition, although the shape (more specifically, the cross-sectional shape) of the plurality of blade teeth tips 42 of the band saw blade 40 is a pointed triangular shape (i.e., flat) in the foregoing embodiments, this is merely exemplary. In other embodiments, the shape of the blade teeth tips 42 may be various other shapes, such as chisel, hollow, scandi, and convex. Furthermore, although a plurality of blade teeth tips 42 are disposed along one side of the width axis of the band saw blade 40 in the foregoing embodiments, this is merely exemplary. In other embodiments, a plurality of blade teeth tips 42 may be disposed along both sides of the width axis of the band saw blade 40.

For example, although the band saw blade 40 is configured to be driven anti-clockwise in the foregoing embodiments, this is merely exemplary. In other embodiments, the band saw blade 40 may be configured to be driven clockwise.

For example, although the foregoing embodiments use one band saw blade 40 to cut the positive electrode terminal 3 side and the negative electrode terminal 6 side of the battery 1, this is merely exemplary. In other embodiments, two band saw blades 40 may be provided so that the respective band saw blades 40 may cut the positive electrode terminal 3 side and the negative electrode terminal 6 side of the battery 1, respectively.

For example, although the drive mechanism 50 includes two saw wheels, the first saw wheel 70 and the second saw wheel 72 in the foregoing embodiments, this is merely exemplary. In other embodiments, the number of saw wheels included in the drive mechanism 50 may be three or more.

For example, although in the foregoing embodiments, the brush 110 is contacted with the band saw blade 40 while running the band saw blade 40 to which the laser beam has been applied in the opposite direction to a predetermined direction, this is merely exemplary. In other embodiments, the brush 110 may be contacted with the band saw blade 40 while running the band saw blade 40 in the predetermined direction.

For example, although the outer shape of the power transmitting means 54, the blowing device 90, the controller 92, and the brush 110 is a rectangular shape in the foregoing embodiments, this is merely exemplary. In other embodiments, the blowing device 90, the power transmitting means 54, the controller 92, and the brush 110 may have various other shapes, such as cylinder and elliptic cylinder.

For example, although in the foregoing embodiments, the blowing device 90 is disposed forward relative to the brush 110 in the drive direction of the band saw blade 40 (the direction along the arrows S, T, and U herein), this is merely exemplary. In other embodiments, the blowing device 90 may be disposed rearward relative to the brush 110 in the drive direction of the band saw blade 40.

For example, although in the foregoing embodiments, the cutting chip removal mechanism 80 includes the blowing device 90 and the brush 110, this is merely exemplary. In other embodiments, the cutting chip removal mechanism 80 may include only one of the blowing device 90 and the brush 110.

For example, although in the foregoing embodiments, driving of the band saw blade 40 is stopped and the band saw blade 40 is heated by the heating device 60 in the heating step S3, this is merely exemplary. In other embodiments, in the heating step S3, the band saw blade 40 may be heated while the band saw blade 40 is being driven.

For example, although the foregoing embodiments use an induction heating coil as the heating device 60, this is merely exemplary. In other embodiments, the heating device 60 may be other devices, such as a burner, a laser, or a resistive heating device that generates resistive heat by passing electric current.

In addition, handling of the battery 1 may be performed by a robot arm. In one example, the work of turning over the battery 1 in the cutting step S1 may be carried out by a robot arm.

As has been described above, the specific embodiments of the technology disclosed herein may include those set forth in the following items.

### Item 1

A method of dismantling an electricity storage device, including:
cutting a case of an electricity storage device with a band saw blade made of a material having a higher melting point than a material making up the case;
heating the band saw blade to a temperature higher than a melting point of the material making up the case and lower than a melting point of the material making up the band saw blade; and
removing cutting chips adhering to the band saw blade by applying an external force to the band saw blade that is heated in the step of heating.

### Item 2

The method according to item 1, wherein:
the case is made of aluminum or an aluminum alloy; and
the band saw blade is made of a steel material.

### Item 3

The method according to item 2, wherein in the step of heating, the band saw blade is heated by electromagnetic induction using an induction heating coil.

### Item 4

4. The method according to any one of items 1 through 3, wherein in the step of removing, a brush is contacted with the band saw blade.

### Item 5

The method according to item 4, wherein in the step of removing, the brush is caused to vibrate.

### Item 6

The method according to any one of items 1 through 5, wherein:
the band saw blade is an annular band saw blade; and
in the step of cutting, the band saw blade runs in a predetermined direction along a predetermined circular path to cut the electricity storage device at a predetermined cut position.

### Item 7

The method according to item 6, wherein in the step of removing, the brush is contacted with the band saw blade while running the band saw blade in an opposite direction to the predetermined direction.

### Item 8

The method according to any one of items 1 through 7, wherein in the step of removing, air is blown onto the band saw blade.

### Item 9

An apparatus of cutting an electricity storage device, including:
a table on which an electricity storage device including a case is to be placed;
a fixture fixing the electricity storage device placed on the table;
a band saw blade made of a material having a higher melting point than a material making up the case;
a drive mechanism driving the band saw blade;
a heating device heating the band saw blade; and
a cutting chip removal mechanism removing cutting chips adhering to the band saw blade by applying an external force to the band saw blade.

### Item 10

The apparatus according to item 9, wherein the cutting chip removal mechanism causes a brush to contact the band saw blade to remove the cutting chips adhering to the band saw blade.

### Item 11

The apparatus according to item 10, wherein the brush is configured to be vibratable.

### Item 12

The apparatus according to any one of items 9 through 11, wherein the cutting chip removal mechanism blows air onto the band saw blade to remove the cutting chips adhering to the band saw blade.

### Item 13

The apparatus according to any one of items 9 through 12, wherein:
the band saw blade is an annular band saw blade;
the drive mechanism includes:
   a first saw wheel around which the band saw blade is wrapped;
   a second saw wheel around which the band saw blade is wrapped; and
   a drive device causes the first saw wheel to rotate to drive the band saw blade along a predetermined circular path; and
the predetermined circular path is configured to pass a predetermined cut position set on the table.

### Item 14

The apparatus according to any one of items 9 through 13, wherein the cutting chip removal mechanism is disposed forward relative to the heating device in a drive direction of the band saw blade.

### Item 15

The apparatus according to any one of items 9 through 14, wherein:
the band saw blade is made of a steel material; and
the heating device is an induction heating coil.

What is claimed is:

1. A method of dismantling an electricity storage device, comprising:
cutting a case of an electricity storage device with a band saw blade made of a material having a higher melting point than a material making up the case;
heating the band saw blade to a temperature higher than a melting point of the material making up the case and lower than a melting point of the material making up the band saw blade; and
removing cutting chips adhering to the band saw blade by applying an external force to the band saw blade that is heated in the step of heating.

2. The method according to claim 1, wherein:
the case is made of aluminum or an aluminum alloy; and
the band saw blade is made of a steel material.

3. The method according to claim 2, wherein in the step of heating, the band saw blade is heated by electromagnetic induction using an induction heating coil.

4. The method according to claim 1, wherein in the step of removing, a brush is contacted with the band saw blade.

5. The method according to claim 4, wherein in the step of removing, the brush is caused to vibrate.

6. The method according to claim 1, wherein:
the band saw blade is an annular band saw blade; and
in the step of cutting, the band saw blade runs in a predetermined direction along a predetermined circular path to cut the electricity storage device at a predetermined cut position.

7. The method according to claim 6, wherein in the step of removing, the brush is contacted with the band saw blade while running the band saw blade in an opposite direction to the predetermined direction.

8. The method according to claim 1, wherein in the step of removing, air is blown onto the band saw blade.

9. An apparatus of cutting an electricity storage device, comprising:
a table on which an electricity storage device including a case is to be placed;
a fixture fixing the electricity storage device placed on the table;
a band saw blade made of a material having a higher melting point than a material making up the case;
a drive mechanism driving the band saw blade;
a heating device heating the band saw blade; and
a cutting chip removal mechanism removing cutting chips adhering to the band saw blade by applying an external force to the band saw blade.

10. The apparatus according to claim 9, wherein the cutting chip removal mechanism causes a brush to contact the band saw blade to remove the cutting chips adhering to the band saw blade.

11. The apparatus according to claim 10, wherein the brush is configured to be vibratable.

12. The apparatus according to claim 9, wherein the cutting chip removal mechanism blows air onto the band saw blade to remove the cutting chips adhering to the band saw blade.

13. The apparatus according to claim 9, wherein:
the band saw blade is an annular band saw blade;
the drive mechanism includes:
a first saw wheel around which the band saw blade is wrapped;
a second saw wheel around which the band saw blade is wrapped; and
a drive device causes the first saw wheel to rotate to drive the band saw blade along a predetermined circular path; and
the predetermined circular path is configured to pass a predetermined cut position set on the table.

14. The apparatus according to claim 9, wherein the cutting chip removal mechanism is disposed forward relative to the heating device in a drive direction of the band saw blade.

15. The apparatus according to claim 9, wherein:
the band saw blade is made of a steel material; and
the heating device is an induction heating coil.
